(19) United States
(12) Patent Application Publication
(10) Pub. No.: US 2023/0334320 A1
(43) Pub. Date: Oct. 19, 2023

(54) Latency-Aware Neural Network Pruning and Applications Thereof

(71) Applicant: Microsoft Technology Licensing, LLC, Redmond, WA (US)

(72) Inventors: Li ZHANG, Beijing (CN); Youkow HOMMA, Bellevue, WA (US); Yujing WANG, Beijing (CN); Min WU, Bothell, WA (US); Mao YANG, Beijing (CN); Ruofei ZHANG, Mountain View, CA (US); Ting CAO, Beijing (CN); Wei SHEN, Bellevue, WA (US)

(73) Assignee: Microsoft Technology Licensing, LLC, Redmond, WA (US)

(21) Appl. No.: 17/722,003

(22) Filed: Apr. 15, 2022

(51) Int. Cl. G06N 3/08; G06N 3/04; G06N 3/10

(52) U.S. Cl. CPC G06N 3/082; G06N 3/0454; G06N 3/10

(57) ABSTRACT

A neural architecture search (NAS) system generates a machine-trained model that satisfies specified real-time latency objectives by selecting among a collection of layer-wise sparse candidate models. In operation, the NAS system selects a parent model from among the candidate models. The NAS system then identifies a particular layer of the parent model, and then determines how the layer is to be mutated, to yield a child model. The NAS system calculates a reward score for the child model based on its latency and accuracy. The NAS system then uses reinforcement learning to update the trainable logic used to perform the mutating based on the reward score. The NAS system repeats the above process a plurality of times. An online application system can use the machine-trained model eventually produced by the NAS system to deliver real-time responses to user queries.

### BACKGROUND

A neural architecture search (NAS) system operates by automatically analyzing different candidate neural network architectures. The NAS system ultimately selects a neural network architecture that best satisfies specified performance objectives. Overall, a NAS system greatly assists a developer in generating a successful machine-trained model for a given application, reducing the need for ad hoc manual analysis and experimentation by the developer. Yet there remains considerable room for improvement in this technical field. For instance, some application environments require a machine-trained model that satisfies stringent real-time latency demands. Online applications, for example, often demand real-time responses to user inputs. Existing NAS systems may fail to produce machine-trained models that satisfy these types of demands, while simultaneously offering acceptable accuracy. The technical literature describes various techniques for reducing the sizes of machine-trained models, such as knowledge distillation, quantization, and weight pruning. But these techniques do not necessarily also produce models that satisfy stringent latency-related objectives.

### SUMMARY

A technique is described herein for generating a machine-trained model that satisfies specified latency-related performance objectives. In some implementations, the technique includes: receiving a specified latency constraint; using neural architecture search to produce the chosen machine-trained model that satisfies the latency constraint, based on a collection of candidate machine-trained models; and applying the chosen machine-trained model in a computer-implemented application system to perform an application task. Different candidate machine-trained models in the collection of machine-trained models specify different respective ways of reducing weights in a shared transformer-based neural network architecture, on a layer-by-layer basis.

In some implementations, the neural architecture search includes selecting a parent model from the collection; and mutating the parent model using trainable logic (referred to herein as a “mutating model”), to produce a child model. The mutating model is specifically trained to select a part of the parent model, and then to mutate the selected part. The technique further includes: generating a reward score for the child model that takes into consideration at least accuracy and latency of the child model; adjusting the mutating model based on the reward score; and updating the collection of candidate machine-trained models based on the child model. The technique repeats the above-identified operations to produce the final chosen machine-trained model, referred to herein as a neural architecture search (NAS) generated model. Overall, the technique combines evolutionary algorithm (EA) operations with reinforcement learning (RL) operations to satisfy latency-related objectives.

In some non-limiting applications, the application system can use the NAS-generated model to provide real-time responses to user queries. For instance, the application system can use the NAS-generated model to process any target item (e.g., a document, digital advertisement, etc.) that has not yet been mapped into an encoding vector as part of a backend processing flow to which all new target items are subjected. The NAS-generated model can satisfy this role because it operates with low latency.

In some implementations, the mutating model selects an attention layer of a transformer-based model. The mutating model then selects a sparsity ratio for this level, which governs a number of attention heads that will removed (if any) in the attention layer. In other cases, the mutating model selects a feed-forward neural network layer of the transformer-based model. The mutating model then selects a sparsity ratio for this level, which governs the number of rows and corresponding columns that will be removed in the weighting matrices used in this level.

In some implementations, the operation of generating the award involves determining the latency and accuracy of the child neural network. The technique can use trainable logic (referred to herein as a “predicting model”) to predict the latency, which avoids the computation-intensive and time-intensive need to directly measure the latency of the child model. The technique can determine the accuracy by performing pruning using a block-based structured pruning operation.

Among its technical merits, the technique provides an effective way of generating a machine-trained model that satisfies real-time latency demands, while also offering satisfactory accuracy. The technique offers superior performance to other neural architecture search algorithms, including those algorithms that uniformly modify the sparsity level of all layers in a neural network. Some application systems can leverage the technique to shorten the amount of time it takes to effectively expose new target items to end users.

The above-summarized technology can be manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative neural architecture system (NAS) system that can generate a machine-trained model that satisfies real-time latency demands.

FIG. 2 shows a transformer-based encoder, which is one type of architecture that the NAS system of FIG. 1 can optimize through selective pruning.

FIG. 3 shows a mutating component, which is a component used in the NAS system of FIG. 1.

FIG. 4 shows a reward-assessing system, which is another component used in the NAS system of FIG. 1.

FIG. 5 illustrates an operating principle underling movement pruning. In some implementations, the reward-assessing system of FIG. 4 is predicated on the use of movement pruning.

FIG. 6 shows examples of blocks of weights that the reward-assessing system of FIG. 4 can remove.

FIG. 7 shows compositions of NAS-generated models produced by the NAS system of FIG. 1, relative to the compositions of other machine-trained models.

FIG. 8 shows the performance of the NAS-generated models produced by the NAS system of FIG. 1, relative to models produced by competing NAS systems.

FIG. 9 shows an illustrative online application system that can use a NAS-generated model produced by the NAS system of FIG. 1.

FIG. 10 shows additional details regarding the application system of FIG. 9.

FIG. 11 shows a process that describes one manner of operation of the NAS system of FIG. 1.

FIG. 12 shows a process that provides further illustrative details regarding the operation of the NAS system of FIG. 1.

FIG. 13 shows a process that describes illustrative details regarding a mutating operation in the process of FIG. 12.

FIGS. 14 and 15 together show a process that describes one manner of operation of the application system of FIG. 9.

FIG. 16 shows computing equipment that can be used to implement the NAS system shown in FIG. 1 and the application system of FIG. 9.

FIG. 17 shows an illustrative type of computing system that can be used to implement any aspect of the features shown in the foregoing drawings.

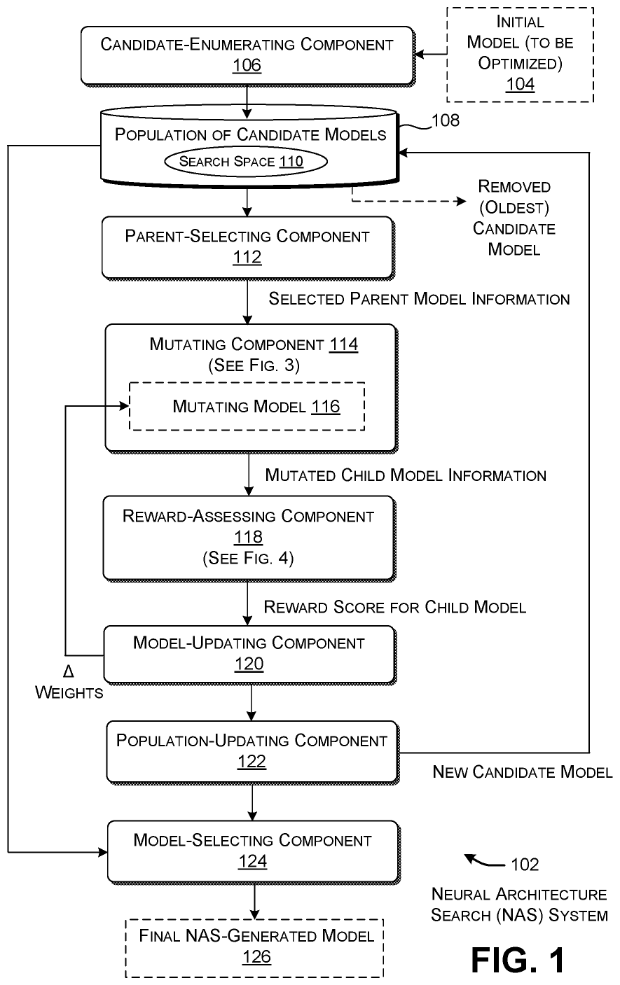

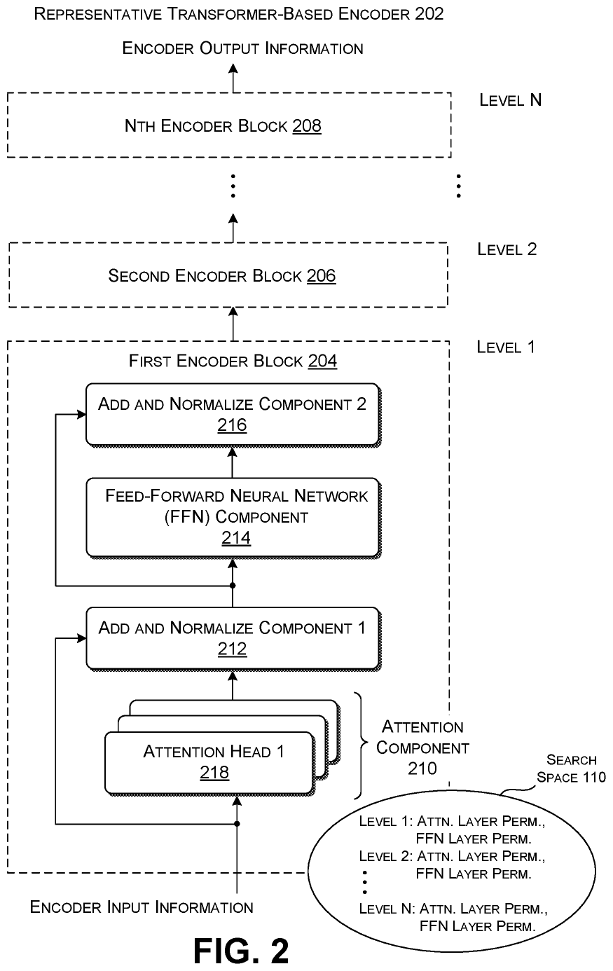

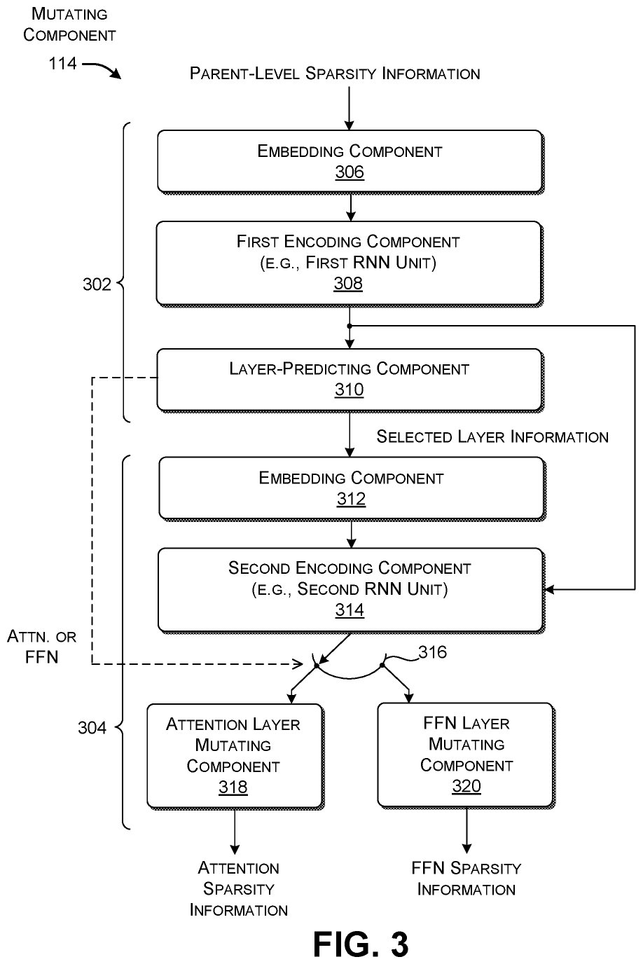

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Subsection A.1 of Section A describes an illustrative neural architecture search (NAS) system for generating a machine-trained model (referred to herein after as a “NAS-generated model”) that satisfies specified performance objectives. Subsection A.2 of Section A describes an application system that uses the NAS-generated model produced by the NAS system of Subsection A.1. Section B sets forth illustrative methods that explain the operation of the systems of Section A. And Section C describes illustrative computing functionality that can be used to implement any aspect of the features described in Sections A and B.
A. Illustrative Systems
A.1. Illustrative NAS System

FIG. 1 shows an illustrative neural architecture system (NAS) system 102 that can generate a machine-trained model (a “NAS-generated model”) that satisfies real-time latency demands, while offering satisfactory accuracy. The NAS system 102 performs its operations by successively considering different permutations of a given base machine-trained model 104 (“base model” for brevity).

The base model 104 generally represents any machine-trained model having weights that have undergone at least some prior training. In some implementations, for example, a preliminary training system (not shown) can train the base model 104 to perform an application-agnostic natural language processing (NLP) task. For example, the preliminary training system can train the base model 104 to predict the identity of words that have been masked in a corpus of linguistic training examples. As will be described below, the NAS system 102 performs fine-tuning of the base model 104 to perform an application-specific NLP task, in conjunction with training its weights. Background information regarding the general topic of pre-training can be found in Devlin, et al., “BERT: Pre-training of Deep Bidirectional Transformers for Language Understanding,” in Proceedings of the 2019 Conference of the North American Chapter of the Association for Computational Linguistics: Human Language Technologies, Vol. 1, June 2019, pp. 4171-4186. In other implementations, the preliminary training system can produce a base model 104 that has already been fine-tuned to some extent, or may be fully trained. In other implementations, the base model 104 can include only randomly initialized weights.

In some implementations, the preliminary training process is specifically configured to produce a base model 104 that is no larger than a specified size. These models are often referred to in the technical literature using qualifiers such as “tiny,” “mini,” etc. The size of a machine-trained model is reflected by the number of weights it uses. With that said, the NAS system 102 can operate on a base model 104 having any size, including models characterized in the literature as “large,” “massive,” etc.

Generally, the base model 104 includes a plurality of layers that perform different functions. For example, FIG. 2, to be described below, shows a transformer-based encoder that includes a plurality of attention layers, each of which includes a specified number of attention heads. The transformer-based encoder also includes a plurality of feed-forward neural network (FFN) layers, each of which includes a feed-forward neural network having a prescribed number of rows and columns. The NAS system 102, however, can operate on neural networks having any type of architecture, such as convolutional neural networks (CNNs), recurrent neural networks (RNNs), etc.

A candidate-enumerating component 106 enumerates (e.g., factorizes) a plurality of candidate models, each of which represents a variation or permutation of the base model 104. In some implementations, the candidate-enumerating component 106 can identify a permutation of the base model 104 by providing metadata that describes the configuration of each of its layers, e.g., by specifying the sparsity ratio for each of its layers. For instance, with respect to a particular attention layer, the candidate-enumerating component 106 can specify a sparsity ratio that identifies how many attention heads are omitted from the attention layer (with respect to a specified maximum number of attention heads). With respect to a particular FFN layer, the candidate-enumerating component 106 can include a sparsity ratio that identifies how many rows (and corresponding columns) of weights are omitted from the FFN layer's weighting matrices (with respect to a maximum number of rows and columns). Generally note that candidate models will exhibit different layer-wise sparsity. This means that different candidate models will specify different respective ways of reducing weights in the base model 104, on a layer-by-layer basis. For example, consider two candidate models. The layer-by-layer sparsity ratios assigned to the first model will not be the same as the layer-by-layer sparsity ratios assigned to the second model in one or more respects. For instance, these two models may assign different sparsity ratios to the same layer. Further, for any given model, different layers are permitted to have different respective sparsity ratios.

A data store 108 stores information regarding each candidate model. For example, the data store 108 can store metadata that describes the sparsity ratio for each layer of the candidate model. The data store 108 can also store the actual weights that compose the candidate model. In some cases, the data store 108 can identify the weights associated with a particular layer by including a reference to the weights. Another candidate model that shares the same weights, in part, can likewise include a reference to the same weights, thereby avoiding needless duplication of weight information. A search space 110 defines a complete population of these candidate models.

Using the remainder of the system components in FIG. 1, the NAS system 102 performs analysis on the candidate models that combines evolutionary algorithm (EA) operations with reinforcement learning (RL) operations in a manner to satisfy latency-related objectives. The NAS system 102 includes EA operations by successively mutating selected candidate models in the population of candidate models. The NAS system 102 performs RL operations to the extent that it assigns reward scores to the models it mutates, and uses the reward scores to update the logic by which it performs model mutation.

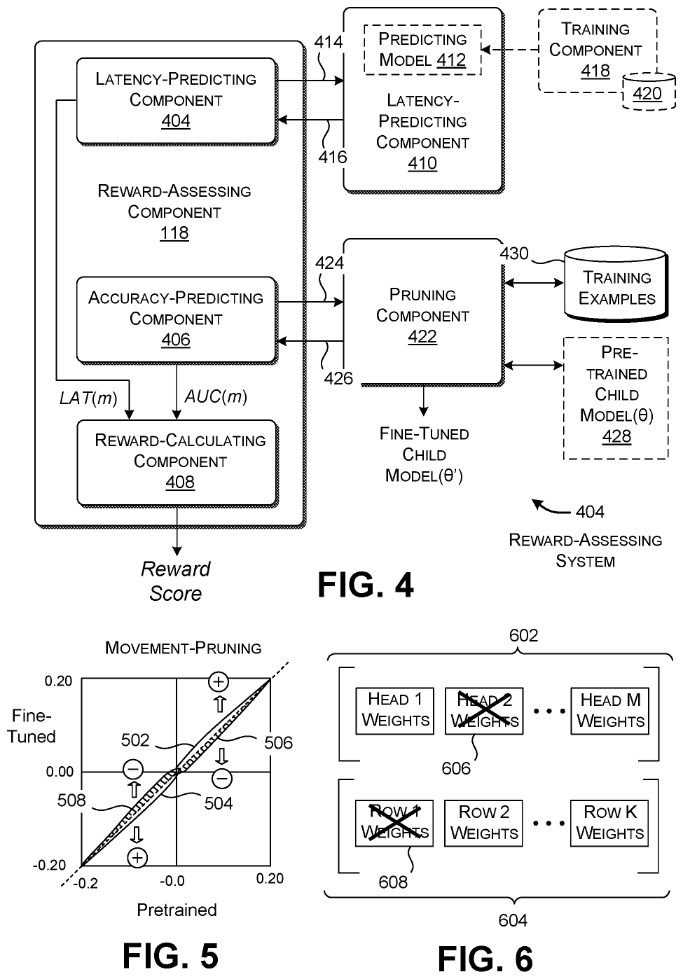

To commence this hybrid process, in some implementations, a parent-selecting component 112 randomly selects a sample of candidate models from the entire population of candidate models in the data store 108. For example, assume that the data store 108 includes metadata that identifies 500 candidate models. The parent-selecting component 112 randomly selects a sample of 50 candidate models from the larger population of 500 models. The parent-selecting component 112 then selects the candidate model within this subset of 50 candidate metals that has a highest (most favorable) reward score. Further details regarding the computation used to determine a reward score for each candidate model is described below with reference to FIG. 4. Suffice it to say here that, in some implementations, the parent-selecting component 112 computes a reward score for each candidate model m based on the latency (LAT(m)) of the candidate model and its accuracy (AUC(m)), among other possible factors. The identified candidate model having the best reward score is referred to below as a “parent model.”

A mutating component 114 next mutates (e.g., varies) the parent model using trainable logic, referred to herein as a “mutating model” 116. This yields a child model. The operation of the mutating component 114 will be described in greater detail below with reference to FIG. 3. As an overview, in a first stage, the mutating component 114 selects a layer of the parent model. In a second stage, the mutating component 114 specifies how the selected layer is to be mutated. For example, assume that the selected layer is an attention layer. In the second stage, the mutating component 114 determines a sparsity ratio for the attention layer, which specifies how many attention heads are to be omitted (if any). Alternatively assume that the selected later is an FFN layer. In the second stage, the mutating component 114 determines a sparsity level for the FFN layer, which specifies how many rows and columns are to be omitted (if any).

A reward-assessing component 118 determines a reward score for the child model identified by the mutating component 114. As noted above, the reward-assessing component 118 determines the reward of the child model based on its latency, which measures how quickly it performs its functions, and its accuracy, which measures how closely its output results match expected output results. Additional information will be provided below regarding the operation of the reward-assessing component 118, with reference to FIG. 4. As will be described at that juncture, the reward-assessing component 118 generates an estimate of the child model's latency using a trainable logic, referred to as a “predicting model.” The use of the predicting model avoids the time-intensive and resource-intensive need for the reward-assessing component 118 to directly measure the latency at which the child model performs its functions.

A model-updating component 120 uses the reward score computed by the reward-assessing component 118 to update the weights of the mutating model 116. For example, for a reward score assessed as favorable for a given set of input factors, the model-updating component 120 can modify the weights of the mutating model 116 to strengthen the likelihood that it will make the same mutation decision when confronted with a similar set of input factors. For a reward score assessed as unfavorable, the model-updating component 120 can modify the weights of the mutating model 116 to weaken the likelihood that it will make the same mutation decision when given a similar set of input factors. In some implementations, the model-updating component 120 can adjust the weights via gradient ascent using any policy-gradient method. A well-known example of a policy-gradient method is the REINFORCE algorithm described in Ronald J. Williams, “Simple Statistical Gradient-Following Algorithms for Connectionist Reinforcement Learning,” in Machine Learning, Vol. 8, 1992, pp. 229-256.

A population-updating component 122 next adds the child model identified by the mutating component 114 to the population of candidate models in the data store 108. The population-updating component 122 can also remove a preexisting candidate model from the population. For example, the population-updating component 122 can remove the oldest candidate model from the population, or the candidate model with the lowest reward score, etc.

The NAS system 102 repeats the above-described process plural times until a prescribed condition is reached. For example, the NAS system 102 can repeat the process a predetermined number of times. Or the NAS system 102 can repeat the process until a prescribed number of candidate models have been identified that satisfy prescribed performance metrics. Once this decision is reached, a model-selecting component 124 can identify the subgroup of candidate models that satisfies a prescribed latency requirement, e.g., which offer latency performance below a prescribed latency threshold. The model-selecting component 124 can then select the candidate model within this subgroup that has the highest accuracy. Other implementations can use other criteria to determine what constitutes the best candidate model, such as by taking into consideration other model properties besides, or in addition to, accuracy. FIG. 1 refers to this selected candidate model as the final NAS-generated model 126. Although not shown, the NAS system 102 can perform further processing on the NAS-generated model 126, e.g., by subjecting it to further fine-tuning, quantization, pruning, etc.

FIG. 2 shows a transformer-based encoder 202. The transformer-based encoder 202 includes a pipeline composed of one or more encoder blocks (204, 206, . . . , 208) operating at plural respective levels (level 1, level 2, . . . , level N). In one implementation, the base model 104 of FIG. 1 exhibits the architecture of the transformer-based encoder 202 shown in FIG. 2, at least in part. FIG. 2 also shows the illustrative composition of the first encoder block 204. Although not shown, the other encoder blocks have the same architecture as the encoder block 204. The encoder block 204 includes its own pipeline of subcomponents at respective sublevels. The encoder block 204 includes, in order, an attention component 210, an add-and-normalize component 212, a feed-forward neural network (FFN) component 214, and a second add-and-normalize component 216.

The attention component 210 performs self-attention analysis using the following equation:

$$attn ( Q , K , V ) = softmax ( \frac{Q {K}^{T}}{\sqrt{d}} ) V . \qquad ( 1 )$$

That is, assume that the attention component 210 receives input information in the form of a collection of input vectors, e.g., representing a series of respective text tokens. The attention component 210 produces query information Q by multiplying the input vectors by a query weight matrix W^{Q}. The attention component 210 produces key information K and value information V by multiplying the same input vectors by a key weight matrix W^{K} and a value weight matrix W^{V}, respectively. To execute Equation (1), the attention component 210 takes the dot product of Q with the transpose of K, and then divides the dot product by a scaling factor V, to produce a scaled result The symbol d represents the dimensionality of the transformer-based encoder 202. The attention component 210 takes the Softmax (normalized exponential function) of the scaled result, and then multiples the result of the Softmax operation by V, to produce attention output information. More generally stated, the attention component 210 determines the importance of each input vector under consideration with respect to every other input vector. Background information regarding the general concept of attention is provided in VASWANI, et al., “Attention Is All You Need,” in 31st Conference on Neural Information Processing Systems (NIPS 2017), 2017, 11 pages.

Note that FIG. 2 shows that the attention component 210 is composed of plural attention heads, including representative attention head 218. Each attention head performs the computations specified by Equation (1), but with respect to a particular representational subspace that is different than the subspaces of the other attention heads. To accomplish this operation, the attention heads perform the computations using different respective sets of query, key, and value weight matrices. Although not shown, the attention component 210 can concatenate the output results of its separate attention heads, and then multiply the results of this concatenation by an output weight matrix W^{O}.

The add-and-normalize component 212 includes a residual connection that combines (e.g., sums) input information fed to the attention component 210 with the output information generated by the attention component 210. The add-and-normalize component 212 then performs a layer normalization operation on the output information generated by of the residual connection, e.g., by normalizing values in the output information based on the mean and standard deviation of those values. The other add-and-normalize component 216 performs the same functions as the first-mentioned add-and-normalize component 212.

The FFN component 214 transforms input information to output information using a feed-forward neural network having any number of layers. In some implementations, the FFN component 214 is a two-layer network that performs its function using the following equation:

FNN(x)=GeLU(xW_{fnn1}+b ₁)W_{fnn2}+b₂ (2).

The symbols W_{fnn1} and W_{fnn2} refer to the two weight matrices used by the FFN component 214, having reciprocal shapes of (d, d_{fnn}) and (d_{fnn}, d), respectively. The symbols b₁ and b₂ represent bias values. GeLU represents a Gaussian Error Linear Unit activation function (e.g., as described in Hendrycks, et al., “Gaussian Error Linear Units (GELUs),” arXiv:1606.08415v3 [cs.LG], Nov. 11, 2018, 9 pages), but any other activation function (such as ReLU) can be used in its place.

In some implementations, a sparsity ratio for an attention layer can be selected from among four possible values (0.00, 0.25, 0.50, and 0.75), respectively corresponding to zero heads omitted, one head omitted, two heads omitted, or three heads omitted, with respect to an environment-specific maximum number of heads (e.g., four heads). A sparsity ratio for an FFN layer can be selected from among 100 values (0.00, 0.01, 0.02, . . . , 0.99), each value of which defines a percentage of rows to be removed from the weight matrix W_{fnn1}, relative to an environment-specific maximum number of rows. Specifying the number of rows also implicitly specifies a corresponding number of columns to be removed in the weight matrix W_{fnn2}. Altogether, the search space 110 defined by the candidate-enumerating component 106 is defined by four attention ratio possibilities and 100 FFN sparsity ratio possibilities for each block level of the transformer-based encoder 202.

In some merely illustrative implementations, the transformer-based encoder 202 is implemented as a 4-level 256-dimensional BERT model with 1024 FFN dimensions. In this case, each candidate model in the data store 108 represents a variation of the mini-BERT architecture. Background on the general topic of BERT models can be found in the above-referenced paper by Devlin, et al. Other implementations can use other types of base model architectures. In addition, or alternatively, other implementations can use other gradations of sparsity ratios compared to those specified above. In addition, or alternatively, other implementations can specify other characteristics of the base model 104 to be varied.

FIG. 3 shows further details regarding the mutating component 114. As previously described, the mutating component 114 mutates the parent model chosen by the parent-selecting component 112, to produce a child model. In some implementations, the mutating component 114 is implemented as a machine-trained model (e.g., the “mutating model” 116 shown in FIG. 1).

The mutating component 114 includes two main subcomponents (302, 304). The first subcomponent 302 selects a layer of the parent model. The second subcomponent 304 determines the manner in which the selected layer is to be changed. Beginning with the first subcomponent 302, this component receives an input vector that describes the sparsity level (e.g., the sparsity ratio) of each layer of the selected parent model. That is, for a 4-level BERT model, the input vector provides an attention sparsity ratio and an FFN sparsity ratio for each of its four encoder blocks. An embedding component 306 can use a linear transform to transform the input vector into an embedding vector. A first encoding component 308 maps the embedding vector into first hidden state information, which reveals the impact of each layer-wise sparsity ratio of the parent model on its performance. In some implementations, the first encoding component 308 is implemented as a first long short-term (LSTM) unit of a two-unit recurrent neural network (RNN). A layer-predicting component 310 maps the first hidden state information produced by the first encoding component 308 to layer mutation probability information, which indicates the suitability of each layer of the parent model for mutation. The layer-predicting component 310 then selects the single layer having the highest probability. In some implementations, the layer-predicting component 310 is implemented as a fully-connected neural network layer followed by a Softmax operation (i.e., a normalized exponential function).

The second subcomponent 304 receives selected layer information. This information includes an index that identifies the layer having the highest probability for mutation identified by the layer-predicting component 310, together with the current sparsity ratio of this layer (in the parent model). Another embedding component 312 maps the selected layer information into an embedding vector. A second encoding component 314 maps the embedding vector, together with the first hidden state information produced by the first encoding component 308, into second hidden state information. In some implementations, the second encoding component 312 is implemented as a second LSTM unit of the two-unit RNN.

A router 316 routes the second hidden state information to an attention layer mutating component 318 if the layer selected by the layer-predicting component 310 is an attention layer. The attention layer mutating component 318 maps the second hidden state information to a sparsity ratio for the attention layer, e.g., which specifies how many attention heads are to be removed, if any. Alternatively, the router 316 routes the second hidden state information to an FFN mutating component 320 if the layer selected by the layer-predicting component 310 is an FFN layer. The FFN layer mutating component 320 maps the second hidden state information to a sparsity ratio for the FFN layer, e.g., which specifies how many rows and columns of weights are to be removed from the FFN layer's weight matrices, if any. Altogether, the identified layer and its associated sparsity level defines how the parent model is to be mutated to create the child model.

FIG. 4 shows a reward-assessing system 402, which includes the reward-assessing component 118 introduced in FIG. 1. The reward-assessing component 118, in turn, includes a latency-predicting component 404 for predicting the latency LAT(m) of the child model m defined by the mutating component 114, an accuracy-predicting component 406 for predicting the accuracy AUC(m) of the child model, and a reward-calculating component 408 for calculating a reward score based on the latency LAT(m) and the accuracy AUC(m). In one implementation, the reward-calculating component 408 generates the reward score using the following equation:

$$reward score = AUC ( m ) \times {[ \frac{L A T ( m )}{T} ]}^{w} . \qquad ( 3 )$$

The symbol T represents an environment-specific target latency of the NAS-generated model 126 being generated. In other words, T represents the latency that the developer wishes not to be exceeded. The symbol w is a weighting factor defined as 0 if LAT (m)≤T , and α otherwise. In some implementations, α is an empirical constant set to —1. From a higher-level standpoint, Equation (3) places full weight on the accuracy of the child model if its latency is less than or equal to the target latency T (because (LAT(m)/T)^{w} reduces to 1 in this circumstance). If the latency is worse than T, then Equation (3) penalizes the model's accuracy based on its latency performance.

The reward-assessing system 402 uses a latency-predicting component 410 to generate the latency LAT(m). In some implementations, the latency-predicting component 410 measures the latency of the child model by actually using the child model to repeatedly process a single input item and/or to process a set of different input items. More specifically, the latency-predicting component 410 computes LAT(m) as the average amount of time that the child model requires to process the input item(s).

In other implementations, the latency-predicting component 410 uses a predicting model 412 to estimate the child model's latency LAT(m), given input information that describes the child model's composition. For example, the input information can describe the sparsity ratio of each of the child model's layers. In operation, the latency-predicting component 404 sends a signal 414 to the predicting model 412 that includes input information describing the child model under consideration. The predicting model 412 returns the estimated latency LAT(m) of the child model in a signal 416.

A training component 418 can produce the predicting model 412 in an offline training process, based on a set of training examples in a data store 420. For example, each training example in the set of training examples can include input information regarding a particular candidate model, together with the measured latency of this candidate model. The training component 418 learns the correlation between different instances of input information and associated latency measures. The predicting model 412 can be implemented as any type of model, such as a random forest classification model, a transformer-based model, a support-vector machine (SVM) model, a convolutional neural network (CNN), a linear regression model, and so on.

In some implementations, the accuracy-predicting component 406 uses a pruning component 422 to determine the accuracy of the child model. In operation, the pruning component 422 receives a signal 424 from the accuracy-predicting component 406 that specifies the sparsity ratio for each layer of the child model. More specifically, the signal 424 specifies the sparsity ratio that has be chosen by the mutating component 114, and the respective sparsity ratios of the child model's other layers. In response, the pruning component 422 applies a pruning algorithm that determines which weights of the child model are to be removed for each of its layers. This applies to the layer selected by the mutating component 114 and the other layers. It then removes the identified weights, e.g., by zeroing out the weights, or by outright deleting the weights and compacting the resultant model, etc. The pruning component 422 also refines the weights of the child model in the course its pruning operation.

In the specific context of an attention layer, the pruning component 422 determines which attention head(s) are to be removed, if any. It then removes the identified attention head(s). More specifically, the pruning component 422 removes an attention head by removing the key, query, value, and output weight matrices associated with this attention head. In the context of an FFN layer, the pruning component 422 identifies the rows and columns of the FFN's weight matrices that are to be removed. It then removes the identified rows and columns.

In some implementations, the pruning component 422 assesses the accuracy of the pruned child model after the pruning operation and/or in the course of the pruning operation. The pruning component 422 accomplishes this result by performing validation testing on a validation training set, e.g., using a Receiver Operating Characteristic (ROC) metric. As a result of its analysis, the pruning component 422 sends a signal 426 to the accuracy-predicting component 406 that identifies the child model's accuracy.

The pruning component 422 can identify a block of weights to remove in a particular layer using different pruning algorithms. In a movement-pruning approach, the pruning component 422 can identify how a block of weights changes in the course of the child model being fine-tuned. FIG. 5 illustrates four ways in which an individual weight can change. In a first case (represented by illustrative weights 502), a positive weight moves away from zero to become more positive in the course of fine-tuning the child model. In a second case (represented by illustrative weights 504), a negative weight moves away from zero to become more negative. In a third case (represented by illustrative weights 506), a positive weight moves toward zero to become less positive. In a fourth case (represented by illustrative weights 508), a negative weight moves toward zero to become less negative. As a general principle, the pruning component 422 identifies the blocks of weights in a given layer that exhibit the most pronounced movement towards zero over the course of fine-tuning, and eliminates a required number of these blocks to satisfy the specified sparsity ratio. Weights that become more positive or more negative are those weights that are assessed as important to the fine-tuning operation, and are thus retained.

To operate in the above manner, the pruning component 422 trains the child model 428 for a set of training examples in a data store 430. In some implementations, the pruning component 422 trains the weights of the child model 428 and a set of importance scores S at the same time. In the particular context of block pruning, each individual importance score identifies the importance of a corresponding block of weights in the child model 428, rather than an individual weight. For example, an importance score may reflect the assessed importance of the weights associated with an entire attention head. In another case, an importance score may reflect the assessed importance of the weights associated with an entire row of an FFN layer (and a corresponding column). The importance scores assigned to blocks change over the course of training. When training is complete, the pruning component 422 determines the blocks of weights that are to be removed in each given layer (if any) based on the importance scores associated with these blocks over the course of training, e.g., based on the final importance scores at the end of training, or the average importance scores over the entire course of training, etc. Blocks associated with lowest importance scores are candidates for removal.

General background information regarding the general concept of movement pruning can be found in Sanh, et al., “Movement Pruning: Adaptive Sparsity by Fine-Tuning,” in 34th Conference on Neural Information Processing Systems (NeurIPS 2020), 2020, 12 pages. General background information regarding the application of movement-pruning to blocks of weights can be found in Lagunas, et al., “Block Pruning For Faster Transformers,” in Proceedings of the 2021 Conference on Empirical Methods in Natural Language Processing, November 2021, pp. 10619-10629. Note, however, that, unlike other pruning technology, the pruning component 422 shown in FIG. 4 determines whether to remove one or more entire attention heads. Removing an entire attention head involves removing all four matrices (key, query, value, output matrices) associated with that head, not merely a block of weights within one of the attention head's matrices. Further, other pruning technology uniformly applies pruning to all layers of the neural network. In contrast, the pruning component 422 shown in FIG. 4 applies layer-wise pruning to the layers of the child model based on sparsity ratios assigned to the child model's layers, in which the sparsity ratio may differ. The layer-wise sparsity ratios include the particular sparsity ratio selected by the mutating component 114 for a particular layer selected by the mutating component 114. The NAS system 102 can improve the latency of the NAS-generated model 126 by performing tuning for the child model's layers using layer-specific sparsity ratios, without compromising the accuracy of the NAS-generated model 126. Further, the pruning component 422 can reduce latency to a greater extent and with reduced complexity, compared to previous block-pruning applications, by removing one or more entire attention heads.

In other implementations, the pruning component 422 can apply other algorithms besides movement pruning to prune the weights. For example, in magnitude pruning, the pruning component 422 removes those weights that have the lowest values, rather than considering the change in weights during training. The pruning component 422 can apply magnitude pruning one or more times during the course of training the child model 428. Magnitude pruning may be an appropriate choice when the base model 104 represents a fully trained model, or a model that has already been fine-tuned to some extent.

The training examples in the data store 430 can originate from different sources. In some cases, each training example can include a query and a corresponding target item (e.g., a particular digital advertisement), together with a label that indicates whether the target item is an acceptable match for the query. The labels for the training examples can be manually provided by a team of human annotators. Alternatively, or in addition, the labels can originate from a teacher machine-trained model (“teacher model”), which has been fully trained to determine whether a target item is an acceptable match for a given query. In this way, the teacher model distills its knowledge in the child model 428. The child model 428 may have a considerably smaller size than the teacher model.

FIG. 6 shows the outcome of pruning performed by the pruning component 422. The child model includes blocks 602 of weights associated with different attention heads at different levels, and blocks 604 of weights associated with FFNs at different levels. FIG. 6 indicates that the pruning operation has removed at least one block 606 of attention weights at a particular level, and at least one row 608 (and corresponding column) of FFN weights at a particular layer.

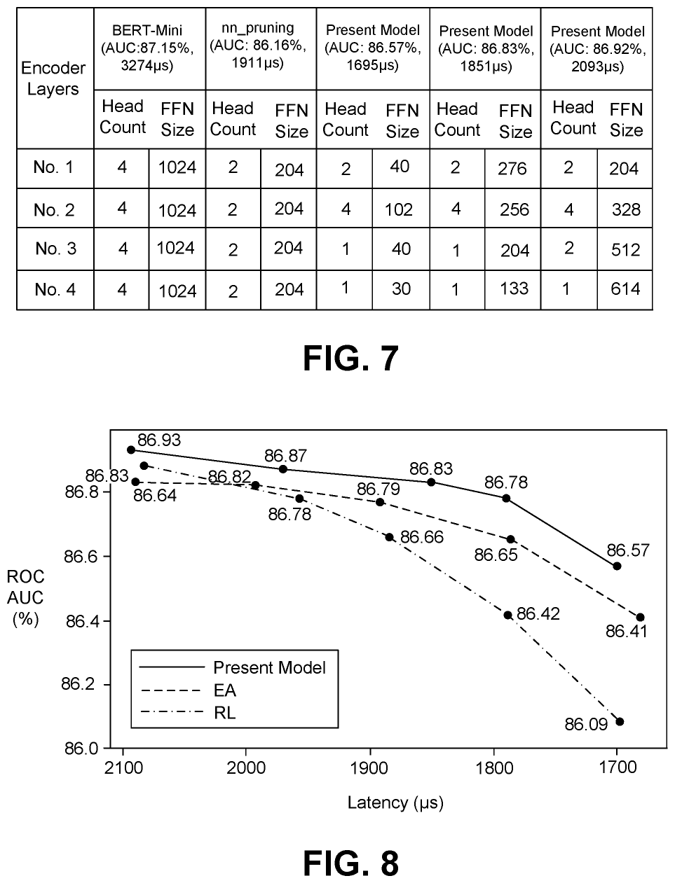

FIG. 7 shows compositions of four-layer NAS-generated models produced by the NAS system 102 of FIG. 1, relative to the compositions of other four-layer machine-trained models. More specifically, the “BERT-Mini” model referenced in FIG. 7 corresponds to a reduced-size BERT model described in Turc, et al., “Well-Read Students Learn Better: On the Importance of Pre-training Compact Models,” in arXiv e-prints arXiv:1908.08962v2 [cs.CL], Sep. 25, 2019, 13 pages. No pruning is applied to produce this model. The “nn_pruning” model referenced in FIG. 7 refers to a model produced using the block-pruning technique described in the above-referenced Lagunas paper. Note that uniform pruning is applied to produce this model. As such, the nn pruning model includes the same number (i.e., two) of attention heads for each of its layers, and it includes the same FFN size (i.e., 205) for each of its FFN layers.

The remaining three models shown in FIG. 7 are produced by the NAS system 102 described herein. First note that the NAS system 102 can produce a model having different numbers of heads at different respective layers. It can also produce a model having different FFN sizes at different respective layers. Again, this differs from the nn pruning model, which includes uniformly reduced attention layers and FFN layers. Further note that the NAS system 102 succeeds in producing models that meet stringent latency demands without significantly compromising accuracy. For example, the first NAS-generating model operates at a latency of 1695 μs with an accuracy of 86.57%. This achieves accuracy that is comparable to the unpruned BERT-Mini model and the uniformly-pruned nn_pruning model, but with significantly better latency performance.

The NAS system 102 produces models that exhibit good latency performance because it is based on the premise that different layers of a model play different roles in producing accurate output results. The NAS system 102 uses this insight to more heavily prune layers that are assessed as being less important compared to layers that are assessed as being more important. Intelligently pruning a machine-trained model has other technical benefits besides improved latency. For example, the NAS system 102 produces models that, because of their reduced sizes, can be transferred and loaded in an efficient manner. The models can also be stored and run on computing platforms having constrained memory and processor resources.

FIG. 8 plots the latency-related and accuracy-related performance of a NAS-generated model produced by the NAS system 102, relative to a model produced using an evolutionary algorithm (EA) approach and a model produced by a reinforcement learning (RL) approach. One example of an EA approach is described in Real, et al., “Regularized Evolution for Image Classifier Architecture Search,” in The Thirty-Third AAAI Conference on Artificial Intelligence (AAAI-19), 2019, pp. 4780-4789. One example of an RL approach is described in Pham, et al., “Efficient Neural Architecture Search via Parameters Sharing,” in Proceedings of the 35th International Conference on Machine Learning, PMLR 80, 2018, pp. 4095-4104. Note that the NAS-generated model represented in FIG. 8 provides superior accuracy at all latency constraints. The advantage of the NAS-generated model is particularly pronounced at the most restrictive latency levels. Note, for instance, that the accuracy of the NAS-generated model trails off much less than the models produced by the RL approach at the most stringent latency levels. More specifically, in one experiment, a NAS-generated model produced by the NAS system 102 achieved a maximum of 43.46% latency reduction on a CPU processing platform for the BERT-Mini model with a minimal AUC loss of 0.32%. Although not shown in FIG. 8, the NAS-generated model produced by the NAS system 102 achieves superior performance to the models produced by some hyper-parameter optimization algorithms.

Subsection A.1 emphasized an example in which the NAS system 102 pruned a transformer-based base model 104 to improve its latency. In other implementations, the NAS system 102 can optimize the performance of base models having other architectures, besides transformer-based models, or in addition to transformer-based models. For example, the NAS system 102 can be used to optimize the performance of a CNN base model, an RNN base model, a hybrid-architecture model, etc. Further note that Subsection A.1 emphasized an example in which the NAS system 102 optimized the performance of the base model 104 by iteratively modifying attention layers and FFN layers. In other implementations, the NAS system 102 can improve the performance of the base model 104 by changing other characteristics of the base model, other than modifying its attention layers and FFN layers, or in addition to modifying its attention layers and FFN layers. For example, consider a CNN base model which does not use attention layers. The mutating component 114 can choose a particular convolutional layer, and then modify a characteristic of that convolutional layer, such as the number of channels it uses, its kernel size, its stride, its input connections (from other layer(s)), etc. More generally, the mutating component 114 can modify any characteristic (e.g., hyper-parameter) of a base model 104 that has an impact on its latency. In other cases, the mutating component 114 can select an FFN layer and choose how many sublayers it includes.
A.2. Representative Application Systems

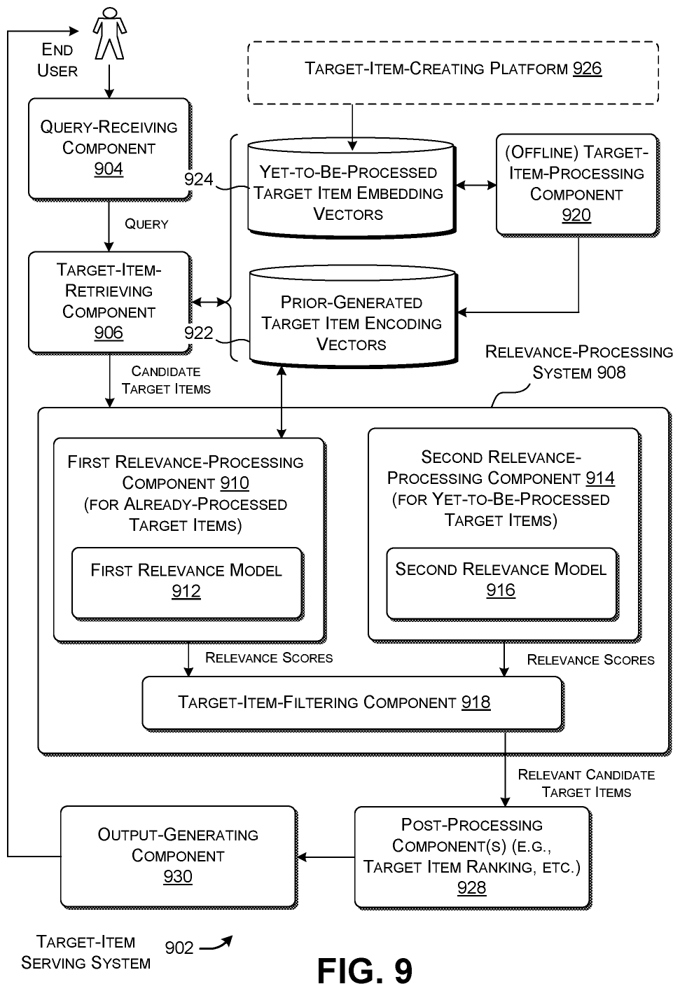

FIG. 9 shows an illustrative online application system 902 that can use a NAS-generated model produced by the NAS system 102 of FIG. 1. The application system 902 receives a query or other request from a user. In response, the application system 902 determines at least one target item that matches the query using, in part, the NAS-generated model. The application system 902 then provides output information to the user that is based on the target item. In one concrete context, the matching target item is a document. Here, the application system 102 can provide a search result page that includes a link to the document, e.g., in a target item snippet. In another context, the target item is a digital advertisement. Here, the application system 902 can provide a page that includes a representation of the digital advertisement, e.g., as an entry in the margin of the page, or as an entry in a list of search results, etc. Still other interpretations of the term “target item” are possible.

More specifically, the application system 902 includes a query-receiving component 904 that receives the user's query. For example, the query-receiving component 904 may correspond to a front-end system of a search engine. The user may interact with the front-end system via a browser application provided by a user computing device. The user's query may include one or more search terms. Or the user's query may include text provided in a page that the user activates using the browser application.

A target-item-retrieving component 906 retrieves a set of preliminary candidate target items that match the user's query. The target-item-retrieving component 906 can perform any combination of search strategies to perform this task, such as lexical matching, semantic matching, etc. In semantic matching, the target-item-retrieving component 906 maps the query and each candidate target item to two respective vectors in a vector space, and then determines how close these vectors are to each other within the vector space (e.g., using cosine similarity).

A relevance-processing system 908 performs the principal task of filtering out candidate target items that are determined to have low relevance to the query, as measured with respect to any environment-specific threshold value. The relevance-processing system 908 ultimately serves the purpose of reducing the amount of erroneous and low quality output information delivered to the user. Examples of low-value out information includes documents and digital advertisements that have low relevance to the user's query.

The relevance-processing system 908 includes at least two relevance-processing engines: a first relevance-processing component 910 that uses a first machine-trained relevance model 912 to process a first class of target items; and a second relevance-processing component 914 that uses a second relevance-processing model 916 to process a second class of target items. Each relevance-processing component generates a relevance score for each target item under consideration in its respective class of target items. A target-item-filtering component 918 eliminates target items having relevance scores below the prescribed threshold value.

The above-referenced first class of target items are target items that have been processed by an offline target-item-processing component 920 in advance of the user's submission of the query. A data store 922 stores the results of processing these target items. A second class of target items are target items that have not yet been processed by the offline target-item-processing component 920. A data store 924 stores this collection of target items. The target-item-processing component 920 is continually processing target items from the data store 924. Upon processing each such target item, it removes a corresponding entry from the data store 924 and adds a new entry in the data store 922.

To provide a more concrete example, assume that target items correspond to digital advertisements created by various advertisers via a target-item-creating platform 926. The data store 924 stores raw data describing the digital advertisements, such as text associated with the digital advertisements, keywords associated with the digital advertisements, etc. For each digital advertisement, the target-item-processing component 920 maps its raw data into a target item encoding vector (“encoding vector” for brevity) in a vector space. The target-item-processing component 920 then stores an entry in the data store 922 that includes or makes reference to the encoding vector for this digital advertisement.

The relevance-processing system 908 includes two relevance-processing components (910, 914) because there is a time lag between the introduction of a new digital advertisement to the data store 924, and the insertion of its corresponding encoding vector in the data store 922. The first relevance-processing component 910 relies on the target item encoding vector for a given target item if this encoding vector exists in the data store 922. The second relevance-processing component 914 must use a different strategy to process a given target item if its corresponding encoding vector does not yet exist in the data store 922. The following description refers to a target item that lacks a corresponding encoding vector as a yet-to-be-processed target item.

One strategy for handling a yet-to-be-processed target item is to compute its encoding vector in real-time on demand. But it takes a considerable amount of time to perform this calculation. In some implementations, this operation may introduce unacceptable latency in the delivery of output information to the user. In yet another strategy, the second relevance-processing component 914 can rely on a less precise algorithm for measuring the relevance of the query to the yet-to-be-processed target item, compared to the relevance analysis performed by the first relevance component 910. But this strategy can lead to errors in judging the relevance of the query to the digital advertisement, which, in turn, can result in the delivery of poor quality output information to the user.

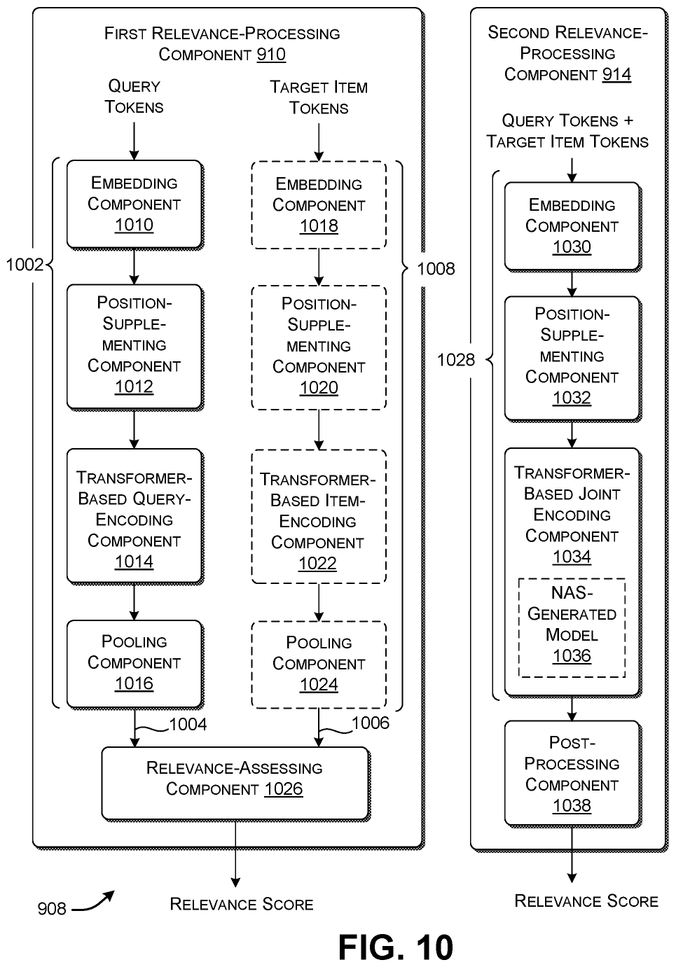

As will be described in greater detail below with reference to FIG. 10, the application system 902 solves the above problem by using a NAS-generated model produced by the NAS system 102 to process each yet-to-be-processed target item identified by the target-item-retrieving component 906. The NAS-generated model is capable of serving this role because it produces highly accurate results with low latency, and therefore does not violate the latency budgets of the application system 902.

One or more post-processing components 928 can perform further processing on the target items that satisfy the relevance test applied by the relevance-processing system 908. For example, a post-processing component can rank the group of relevant target items identified by the relevance-processing system 908. The post-processing component(s) 928 can perform this task using any type of machine-trained model. Background information regarding one approach to online ranking of target items is provided in Phophalia, Ashish, “A Survey on Learning To Rank (LETOR) Approaches in Information Retrieval,” in 2011 Nirma University International Conference on Engineering, 2011, pp. 1-6. In general, the post-processing component(s) 928 can rank target items based on multiple factors, including the relevance scores computed by the relevance-processing system 908, user click-through rate information, bidding price information, user intent information, and so on. An output-generating component 930 provides output information based on the results produced by the post-processing component(s) 928. As stated above, the output information can take the form of a search result page, digital advertisements inserted into a page that the user is viewing, and so on.

FIG. 10 shows additional detail regarding the first relevance-processing component 910 and the second relevance-processing component 914 of FIG. 10. To repeat, the first relevance-processing component 910 is devoted to the task of processing target items for which encoding vectors currently exist. The second relevance-processing component 914 is devoted to processing yet-to-be-processed target items (for which encoding vectors do not yet exist).

Referring to the first relevance-processing component 910, this component includes a first processing path 1002 for converting an input query into a query encoding vector 1004. It also makes reference to a target item encoding vector 1006 produced by a second processing path 1008. Note that the second processing path 1008 is actually performed offline by the target-item-processing component 920 of FIG. 9; FIG. 10 shows the second processing path 1008 as a virtual part of first relevance-processing component 910 to facilitate understanding of the totality of operations by which the application system 902 generates a relevance score. In contrast, the steps in the first processing path 1002 are performed in real time when the user submits the query.

Referring to the first processing path 1002, an embedding component 1010 breaks the input query into text tokens, e.g., corresponding to individual words, character n-grams, WordPiece fragments, byte pair encoding (BPE) fragments, etc. The embedding component 1010 can represent the text tokens as one-hot vectors. The embedding component 1010 can then map the one-hot vectors into embedding vectors, e.g., using a linear transformation layer. A position supplementing-component 1012 adds position information to each embedding vector, to produce position-supplemented embedding vectors. The position information added to each embedding vector describes its position in the sequence of text tokens. A transformer-based query-encoding component 1014 uses the same architecture shown in FIG. 2 to map the position-supplemented embedding vectors into encoder output information, which includes plural encoding output vectors. A pooling component 1016 maps the plural encoding output vectors into the encoding vector 1004 for the query, e.g., using weighted-average pooling, classification-based pooling, or some other type of aggregating function.

The second processing path 1008 includes the same operations as the first processing path 1002. That is, the second processing path 1008 includes an embedding component 1018, a position-supplementing component 1020, a transformer-based item-encoding component 1022, and a pooling component 1024. The second processing path 1008 yields the encoding vector 1006 for the target item. A relevance-assessing component 1026 computes a relevance score by determining the proximity of the query encoding vector 1004 to the target item encoding vector 1006 in vector space. In some implementations, the relevance-assessing component 1026 performs this task by computing a cosine distance measure.

The second relevance-processing component 914 includes a third processing path 1028 that also shares the same basic architecture as the first and second processing paths (1002, 1008). More specifically, the third processing path 1028 includes an embedding component 1030, a position-supplementing component 1032, and a transformer-based joint encoding component 1034. However, in the case of the third processing path 1028, the embedding component 1030 receives text information that includes the concatenation of text tokens associated with the query and text tokens associated with the yet-to-be-processed target item. Further, in the third processing path 1028, the transformer-based joint encoding component 1034 uses a NAS-generated model 1036 produced by the NAS system 102 of FIG. 1. As described above, the NAS-generated model 1036 is configured to satisfy strict latency demands, which allows the application system 902 to provide output information to a user in real time upon the user's submission of a query. A post-processing component 1038 can perform any post-processing operations on the encoder output information generated by the transformer-based joint encoding component 1034. For example, the post-processing component 1038 can include a fully-connected neural network layer followed by a Softmax layer. The post-processing component 1038 generates a relevance score that identifies the relevance of the input query to the yet-to-be-processed target item under consideration.

In addition to the merits of improved latency, the application system 902 of FIG. 2 enjoys downstream benefits from its use of the NAS-generated model 1036. For example, the application system 902 can improve the accuracy of target items (e.g., digital advertisements) it delivers to users through the use of the NAS-generated model 1036. This is because a developer is no longer forced to use a less accurate model to process yet-to-processed target items in an attempt to satisfy latency demands. By delivering more accurate target items, the application system 902 can increase the end users' interaction with these items, e.g., as measured by click-through rate or any other measure of end user interest.

The application system 902 shown in FIGS. 9 and 10 is just one example of a class of application systems that perform, as a preliminary operation, backend processing on target items to produce an analysis result, such as by producing encoding vectors for the target items. These application systems later provide some service to end users based on the analysis result produced by the backend processing. These application systems are not capable of effectively exposing the newly introduced target items to the end users until the backend processing has been completed. As described above, a developer can address this problem by making use of a NAS-generated model to handle newly introduced target items that have not yet been subjected to the backend processing. Such an application system can process the target items that have already been processed using its legacy machine-trained model that relies on the analysis result produced by the backend processing. In this manner, a developer can more quickly expose new target items to end users without compromising the quality of the output information delivered to end users.

Consider another example of an application system in the above class. A newsfeed application system can perform preliminary processing on batches of news-related documents that it receives from one or more sources. For example, the newsfeed application system can convert each news-related document into a semantic vector in a vector space. The semantic vector represents the topic(s) of the news-related document. The newsfeed application system can then expose end users to the news-related documents. For example, upon discovering that a particular document pertains to a particular topic, the newsfeed application system can post the document to a home page devoted to that particular topic, or send a targeted alert to subscribers of that topic, etc. This kind of application system can make use of a NAS-generated model to more quickly expose a new document to end users before the backend preliminary processing has been completed.

Further note that the application system 902 of FIGS. 9 and 10 is predicated on the use of two machine-trained models: a first model 912 which consumes encoding vectors produced by the backend target item processing component 920, and a second model (916, 1036) which processes target items that have not yet been processed by the target item processing component 920. In other implementations, an application system can use only the NAS-generated model (916, 1036).

Other application systems can use NAS-generated models for other respective purposes. For example, another NLP application system can use a NAS-generated model to automatically convert raw input information regarding a digital advertisement into keywords associated with the digital advertisement and/or the ad creative that is presented to the user upon triggering the ad. Other applications can use a NAS-generated model to detect the user's query intent, to detect the user's sentiment, to detect entities within a user's utterance, to detect the topics associated with a user's question, and so on.

Further, the use of NAS-generated models is not limited to NLP application systems. For example, another application system can use a NAS-generated model to detect features of an input image or input video snippet, or to compare the input image with a target image, etc. In this case, the application system can make use of a video-based transformer architecture instead of an NLP-based transformer architecture. Yet another application system can use a NAS-generated model to detect content in an input audio item, or to compare the input audio item with a target audio item. In this case, the application system can make use of an audio-based transformer architecture instead of an NLP-based transformer architecture. As further noted at the end of Subsection A.1, an application system can use an NAS-generated model that implements some other neural network architecture besides, or in addition to, a transformer-based architecture.

Still other applications are possible. The above examples are set forth by way of example, not limitation.
B. Illustrative Processes

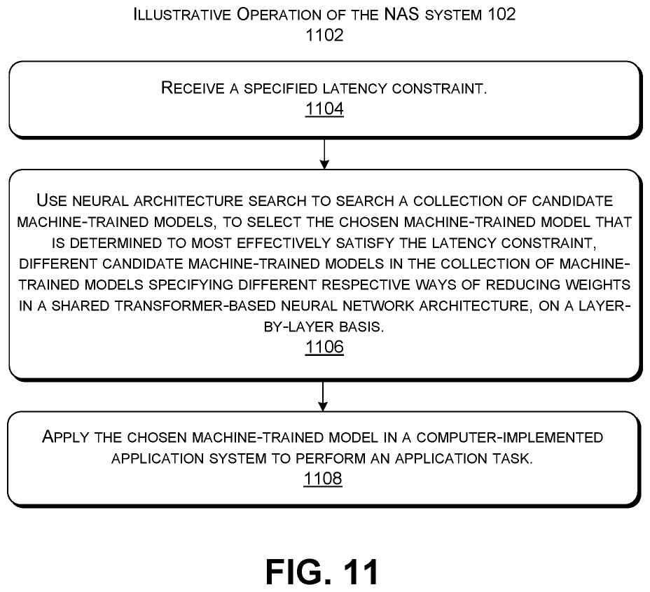

FIGS. 11-15 show processes that explain the operation of the NAS system 102 and application system 902 of Section A in flowchart form, according to some implementations. Since the principles underlying the operation of the systems (102, 902) have already been described in Section A, certain operations will be addressed in summary fashion in this section. Each flowchart is expressed as a series of operations performed in a particular order. But the order of these operations is merely representative, and can be varied in other implementations. Further, any two or more operations described below can be performed in a parallel manner. In some implementations, the blocks shown in the flowcharts that pertain to processing-related functions are implemented by the hardware logic circuitry described in Section C, which, in turn, can be implemented by one or more hardware processors and/or other logic units that include a task-specific collection of logic gates.

FIG. 11 shows a process 1102 for identifying and applying a chosen machine-trained model using the NAS system 102 of FIG. 1. In block 1104, the NAS system 102 receives a specified latency constraint T. In block 1106, the NAS system 102 uses neural architecture search to produce the chosen machine-trained model that satisfies the latency constraint, based on a collection of candidate machine-trained models. Different candidate machine-trained models in the collection of machine-trained models specify different respective ways of reducing weights in a shared transformer-based neural network architecture (e.g., the base model 104), on a layer-by-layer basis. In block 1108, the chosen machine-trained model is applied in a computer-implemented application system 902 to perform an application task.

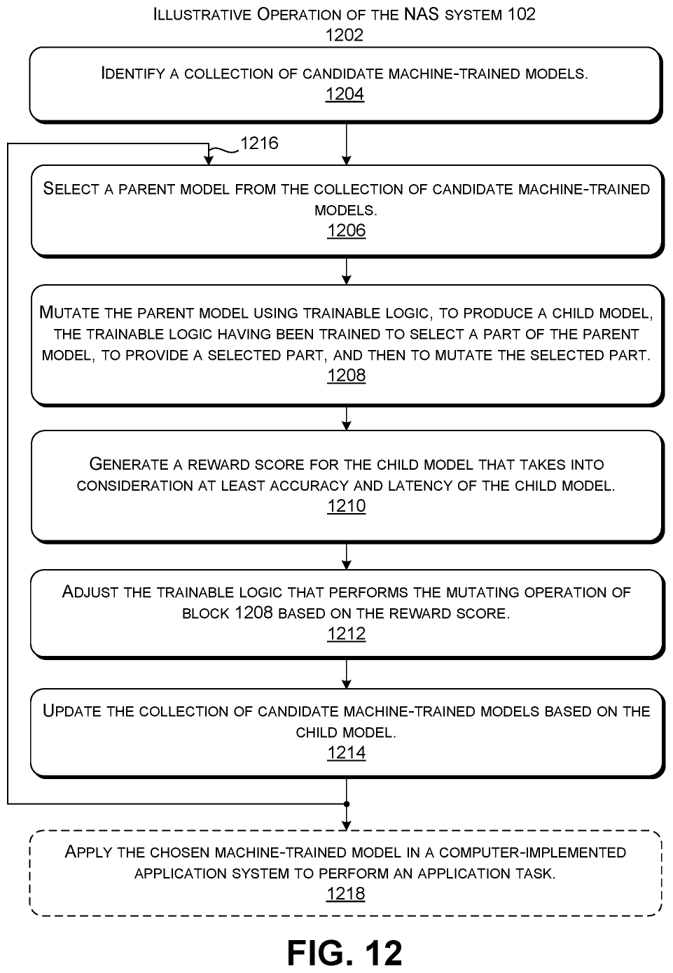

FIG. 12 shows a process 1202 that provides further illustrative details of the NAS system 102 of FIG. 1. In block 1204, the NAS system 102 identifies a collection of candidate machine-trained models. In block 1206, the NAS system 102 selects a parent model from the collection of candidate machine-trained models. In block 1208, the NAS system 102 mutates the parent model using trainable logic, to produce a child model, the trainable logic having been trained to select a part of the parent model, to provide a selected part, and then to mutate the selected part. In block 1210, the NAS system 102 generates a reward score for the child model that takes into consideration at least accuracy and latency of the child model. In block 1212, the NAS system 102 adjusts the trainable logic that performs the mutating operation of block 1108 based on the reward score. In block 1214, the NAS system 102 updates the collection of candidate machine-trained models based on the child model. The loop 1216 indicates that the NAS system 102 repeats the operations of selecting, mutating, generating, adjusting, and updating until a specified objective is achieved, to produce the chosen machine-trained model. In some implementations, in block 1218, an application system 902 applies the chosen machine-trained model to perform an application task.

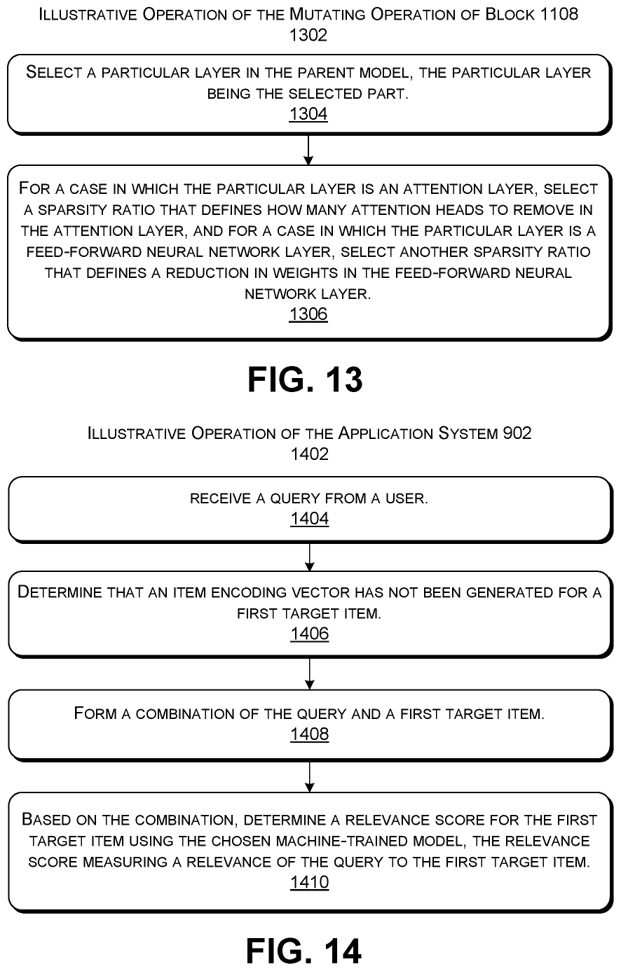

FIG. 13 shows a process 1302 that provides further details regarding one implementation of block 1208 of FIG. 12. In block 1304, the NAS system 102 selects a layer in the parent model, the particular layer being the above-referenced selected part. In block 1306, for a case in which the particular layer is an attention layer, the NAS system 102 selects a sparsity ratio that defines how many attention heads to remove in the attention layer. For a case in which the particular layer is a feed-forward neural network layer, the NAS system selects another sparsity ratio that defines a reduction in weights in the feed-forward neural network layer.

FIG. 14 is a process 1402 that summarizes one manner of operation of the application system 902 of FIG. 9. In block 1404, the application system 902 receives a query from a user. In block 1406, the application system 902 determines that an item encoding vector has not been generated for a first target item. In block 1408, the application system 902 forms a combination of the query and a first target item. In block 1410, based on the combination, the application system 902 determines a relevance score for the first target item using the chosen machine-trained model (e.g., second relevance model 916) provided by the NAS system 102, the relevance score measuring a relevance of the query to the first target item.

Although not shown in FIG. 14, a further aspect of the process 1402 entails the following operations. In another operation, the application system 902 determines that an item encoding vector has been generated for a second target item. The application system 902 then retrieves that item encoding vector, the item encoding vector representing semantic content in the second target item and having been generated in an offline process prior to receipt of the query. In another operation, the application system 902 determines a relevance score for the second target item using another machine-trained model (e.g., the first relevance model 912), different from the chosen machine-trained model, based on the item encoding vector that is retrieved. The relevance score for the second target item measures a relevance of the query to the second target item.

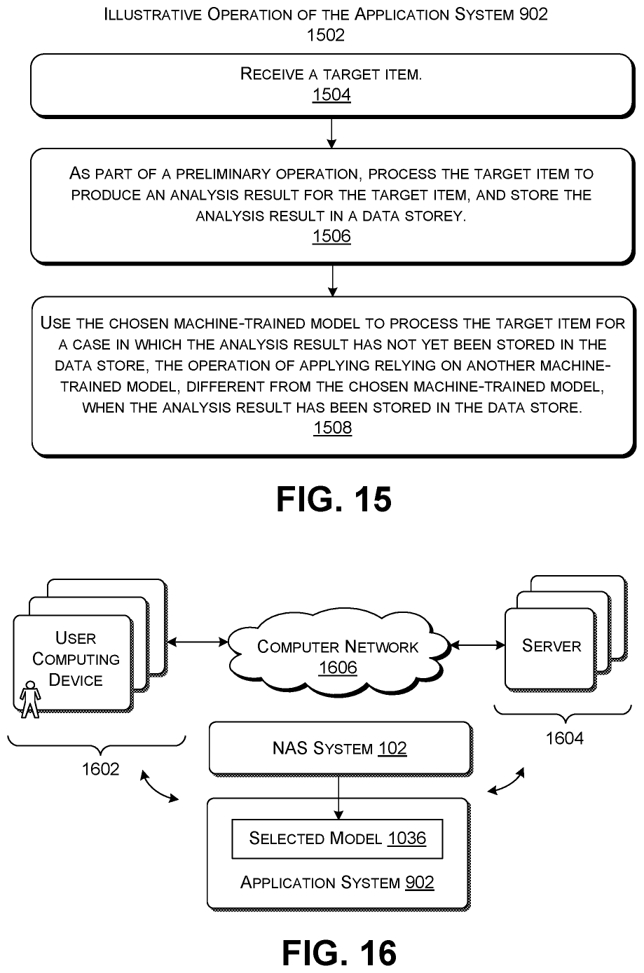

FIG. 15 shows a process 1502 that describes other characteristics of the application system 902. In block 1504, the application system 902 receives a target item. In block 1506, as part of a preliminary operation, the application system 902 processes the target item to produce an analysis result for the target item, and stores the analysis result in a data store (e.g., data store 922). In block 1508, the application system 902 uses the chosen machine-trained model (e.g., the second relevance model 916) to process the target item for a case in which the analysis result has not yet been stored in the data store. The application system 902 alternatively relies on another machine-trained model (e.g., the first relevance model 912), different from the chosen machine-trained model, when the analysis result has been stored in the data store.
C. Representative Computing Functionality

FIG. 16 shows an example of computing equipment that can be used to implement any of the systems summarized above. The computing equipment includes a set of user computing devices 1602 coupled to a set of servers 1604 via a computer network 1606. Each user computing device can correspond to any device that performs a computing function, including a desktop computing device, a laptop computing device, a handheld computing device of any type (e.g., a smartphone, a tablet-type computing device, etc.), a mixed reality device, a wearable computing device, an Internet-of-Things (IoT) device, a gaming system, and so on. The computer network 1606 can be implemented as a local area network, a wide area network (e.g., the Internet), one or more point-to-point links, or any combination thereof.

FIG. 16 also indicates that NAS system 102 and the application system 902 can be spread across the user computing devices 1602 and/or the servers 1604 in any manner. For instance, in some cases, the application system 902 is entirely implemented by one or more of the servers 1604. Each user may interact with the servers 1604 via a user computing device. In other cases, an application system 902 is entirely implemented by a user computing device in local fashion, in which case no interaction with the servers 1604 is necessary. In another case, the functionality associated with an application system 902 is distributed between the servers 1604 and each user computing device in any manner.

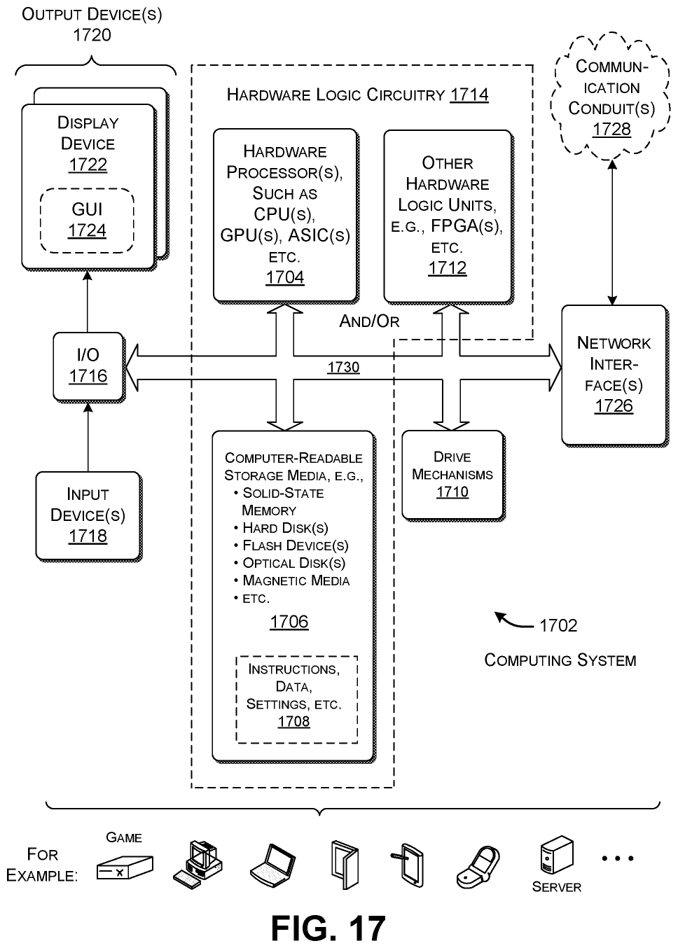

FIG. 17 shows a computing system 1702 that can be used to implement any aspect of the mechanisms set forth in the above-described figures. For instance, the type of computing system 1702 shown in FIG. 17 can be used to implement any user computing device or any server shown in FIG. 16. In all cases, the computing system 1702 represents a physical and tangible processing mechanism.

The computing system 1702 can include one or more hardware processors 1704. The hardware processor(s) 1704 can include, without limitation, one or more Central Processing Units (CPUs), and/or one or more Graphics Processing Units (GPUs), and/or one or more Application Specific Integrated Circuits (ASICs), and/or one or more Neural Processing Units (NPUs), etc. More generally, any hardware processor can correspond to a general-purpose processing unit or an application-specific processor unit.

The computing system 1702 can also include computer-readable storage media 1706, corresponding to one or more computer-readable media hardware units. The computer-readable storage media 1706 retains any kind of information 1708, such as machine-readable instructions, settings, data, etc. Without limitation, the computer-readable storage media 1706 may include one or more solid-state devices, one or more magnetic hard disks, one or more optical disks, magnetic tape, and so on. Any instance of the computer-readable storage media 1706 can use any technology for storing and retrieving information. Further, any instance of the computer-readable storage media 1706 may represent a fixed or removable unit of the computing system 1702. Further, any instance of the computer-readable storage media 1706 may provide volatile or non-volatile retention of information.

More generally, any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se in transit, while including all other forms of computer-readable media.

The computing system 1702 can utilize any instance of the computer- readable storage media 1706 in different ways. For example, any instance of the computer-readable storage media 1706 may represent a hardware memory unit (such as Random Access Memory (RAM)) for storing information during execution of a program by the computing system 1702, and/or a hardware storage unit (such as a hard disk) for retaining/archiving information on a more permanent basis. In the latter case, the computing system 1702 also includes one or more drive mechanisms 1710 (such as a hard drive mechanism) for storing and retrieving information from an instance of the computer-readable storage media 1706.

The computing system 1702 may perform any of the functions described above when the hardware processor(s) 1704 carry out computer-readable instructions stored in any instance of the computer-readable storage media 1706. For instance, the computing system 1702 may carry out computer-readable instructions to perform each block of the processes described in Section B.

Alternatively, or in addition, the computing system 1702 may rely on one or more other hardware logic units 1712 to perform operations using a task-specific collection of logic gates. For instance, the hardware logic unit(s) 1712 may include a fixed configuration of hardware logic gates, e.g., that are created and set at the time of manufacture, and thereafter unalterable. Alternatively, or in addition, the other hardware logic unit(s) 1712 may include a collection of programmable hardware logic gates that can be set to perform different application-specific tasks. The latter class of devices includes, but is not limited to Programmable Array Logic Devices (PALs), Generic Array Logic Devices (GALs), Complex Programmable Logic Devices (CPLDs), Field-Programmable Gate Arrays (FPGAs), etc.

FIG. 17 generally indicates that hardware logic circuitry 1714 includes any combination of the hardware processor(s) 1704, the computer-readable storage media 1706, and/or the other hardware logic unit(s) 1712. That is, the computing system 1702 can employ any combination of the hardware processor(s) 1704 that execute machine-readable instructions provided in the computer-readable storage media 1706, and/or one or more other hardware logic unit(s) 1712 that perform operations using a fixed and/or programmable collection of hardware logic gates. More generally stated, the hardware logic circuitry 1714 corresponds to one or more hardware logic units of any type(s) that perform operations based on logic stored in and/or otherwise embodied in the hardware logic unit(s). Further, in some contexts, each of the terms “component,” “module,” “engine,” “system,” and “tool” refers to a part of the hardware logic circuitry 1714 that performs a particular function or combination of functions.

In some cases (e.g., in the case in which the computing system 1702 represents a user computing device), the computing system 1702 also includes an input/output interface 1716 for receiving various inputs (via input devices 1718), and for providing various outputs (via output devices 1720). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers, gyroscopes, etc.), and so on. One particular output mechanism may include a display device 1722 and an associated graphical user interface presentation (GUI) 1724. The display device 1722 may correspond to a liquid crystal display device, a light-emitting diode display (LED) device, a cathode ray tube device, a projection mechanism, etc. Other output devices include a printer, one or more speakers, a haptic output mechanism, an archival mechanism (for storing output information), and so on. The computing system 1702 can also include one or more network interfaces 1726 for exchanging data with other devices via one or more communication conduits 1728. One or more communication buses 1730 communicatively couple the above-described units together.

The communication conduit(s) 1728 can be implemented in any manner, e.g., by a local area computer network, a wide area computer network (e.g., the Internet), point-to-point connections, etc., or any combination thereof. The communication conduit(s) 1728 can include any combination of hardwired links, wireless links, routers, gateway functionality, name servers, etc., governed by any protocol or combination of protocols.

FIG. 17 shows the computing system 1702 as being composed of a discrete collection of separate units. In some cases, the collection of units corresponds to discrete hardware units provided in a computing device chassis having any form factor. FIG. 17 shows illustrative form factors in its bottom portion. In other cases, the computing system 1702 can include a hardware logic unit that integrates the functions of two or more of the units shown in FIG. 1. For instance, the computing system 1702 can include a system on a chip (SoC or SOC), corresponding to an integrated circuit that combines the functions of two or more of the units shown in FIG. 17.

The following summary provides a non-exhaustive set of illustrative examples of the technology set forth herein.

(A1) According to a first aspect, some implementations of the technology described herein include a method (e.g., the process 1102) for identifying and applying a chosen machine-trained model (e.g., the NAS-generated model 126). The method includes: receiving (e.g., 1104) a specified latency constraint; and using (e.g., 1106) neural architecture search to produce the chosen machine-trained model that satisfies the latency constraint, based on a collection of candidate machine-trained models. Different candidate machine-trained models in the collection of machine-trained models specify different respective ways of reducing weights in a shared transformer-based neural network architecture, on a layer-by-layer basis. The method further includes applying (e.g., 1108) the chosen machine-trained model in a computer-implemented application system (e.g., 902) to perform an application task. The method of A1 has a technical merit of producing a machine-trained model with reduced latency, while not unduly comprising the accuracy of the model. The application system can leverage the machine-trained model to quickly expose new target items to end users.

(A2) According to some implementations of the method of A1, the candidate machine-trained models in the collection of candidate machine-trained models include attention layers having different numbers of attention heads and feed-forward neural network layers having different sizes.

(A3) According to some implementations of any of the methods of A1 or A2, the neural architecture search includes: selecting a parent model from the collection of candidate machine-trained models; mutating the parent model using trainable logic, to produce a child model, the trainable logic having been trained to select a part of the parent model, to provide a selected part, and then to mutate the selected part; generating a reward score for the child model that takes into consideration at least accuracy and latency of the child model; adjusting the trainable logic that performs the mutating operation based on the reward score; updating the collection of candidate machine-trained models based on the child model; and repeating the above operations until a specified objective is achieved, to produce the chosen machine-trained model.

(A4) According to some implementations of the method of A3, the operation of selecting operates by selecting the parent model based on latency and accuracy exhibited by the parent model, relative to latency and accuracy exhibited by other candidate machine-trained models.

(A5) According to some implementations of any of the methods of A3 or A4, the operation of mutating includes: selecting a particular layer in the parent model, the particular layer being the selected part; and for a case in which the particular layer is an attention layer, selecting a sparsity ratio that defines how many attention heads to remove in the attention layer, and for a case in which the particular layer is a feed-forward neural network layer, selecting another sparsity ratio that defines a reduction in weights in the feed-forward neural network layer.

(A6) According to some implementations of any of the methods of A3-A5, the latency that is used to generate the reward score is produced using trainable logic that performs prediction.

(A7) According to some implementations of any of the methods of A3-A6, the accuracy that is used to generate the reward score is produced by performing pruning on the parent model.

(A8) According to some implementations of any of the methods of A3-A7, the operation of adjusting involves adjusting weights in the trainable logic that performs the mutating operation based on a reinforcement learning training objective.

(A9) According to some implementations of any of the methods of A3-A8, the operation of updating involves adding the chosen machine-trained model to the collection of candidate machine-trained models, and removing at least one existing candidate machine-trained model from the collection of candidate machine-trained models.

(A10) According to some implementations of any of the methods of A1-A9, the operation of applying includes: receiving a target item; as part of a preliminary operation, processing the target item to produce an analysis result for the target item, and storing the analysis result in a data store; and using the chosen machine-trained model to process the target item for a case in which the analysis result has not yet been stored in the data store. The operation of applying relies on another machine-trained model, different from the chosen machine-trained model, when the analysis result has been stored in the data store.

(A11) According to some implementations of any of the methods of A1-A9, the operation of applying includes: receiving a query from a user; forming a combination of the query and a first target item; and based on the combination, determining a relevance score for the first target item using the chosen machine-trained model, the relevance score measuring a relevance of the query to the first target item.

(A12) According to some implementations of the method of A11, the operation of applying further includes: retrieving an item encoding vector for a second target item, the item encoding vector representing semantic content in the second target item and having been generated in an offline process prior to receipt of the query; and determining a relevance score for the second target item using another machine-trained model, different from the chosen machine-trained model, based on the item encoding vector that is retrieved, the relevance score for the second target item measuring a relevance of the query to the second target item. The chosen machine-trained model is used in response to determining that an item encoding vector has not yet been generated for the first target item.

(B1) According to another illustrative aspect, some implementations of the technology described herein include a method (e.g., the process 1202) for identifying and applying a chosen machine-trained model (e.g., the NAS-generated model 126). The method includes: identifying (e.g., block 1204) a collection of candidate machine-trained models; selecting (e.g., block 1206) a parent model from the collection of candidate machine-trained models; mutating (e.g., block 1208) the parent model using trainable logic (e.g., the mutating model 116), to produce a child model, the trainable logic having been trained to select a part of the parent model, to provide a selected part, and then to mutate the selected part; generating (e.g., block 1210) a reward score for the child model that takes into consideration at least accuracy and latency of the child model; adjusting (e.g., block 1212) the trainable logic that performs the mutating operation based on the reward score; updating (e.g., block 1214) the collection of candidate machine-trained models based on the child model; and repeating (e.g., loop 1216) the above operations until a specified objective is achieved, to produce the chosen machine-trained model. In some implementations, the method further includes applying (e.g., block 1218) the chosen machine-trained model in a computer-implemented application system (e.g., 902) to perform an application task

In yet another aspect, some implementations of the technology described herein include a computing system (e.g., computing system 1702). The computing system includes hardware logic circuitry (e.g., 1714) that is configured to perform any of the methods described herein (e.g., any of the methods of A1-A12 or B1).

In yet another aspect, some implementations of the technology described herein include a computer-readable storage medium (e.g., the computer-readable storage media 1706) for storing computer-readable instructions (e.g., 1708). One or more hardware processors (e.g., 1704) execute the computer-readable instructions to perform any of the methods described herein (e.g., any of the methods of A1-A12 or B1).

More generally stated, any of the individual elements and steps described herein can be combined, without limitation, into any logically consistent permutation or subset. Further, any such combination can be manifested, without limitation, as a method, device, system, computer-readable storage medium, data structure, article of manufacture, graphical user interface presentation, etc. The technology can also be expressed as a series of means-plus-format elements in the claims, although this format should not be considered to be invoked unless the phase “means for” is explicitly used in the claims.

As to terminology used in this description, the phrase “configured to” encompasses various physical and tangible mechanisms for performing an identified operation. The mechanisms can be configured to perform an operation using the hardware logic circuity 1714 of Section C. The term “logic” likewise encompasses various physical and tangible mechanisms for performing a task. For instance, each processing-related operation illustrated in the flowcharts of Section B corresponds to a logic component for performing that operation.

This description may have identified one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Further, the term “plurality” refers to two or more items, and does not necessarily imply “all” items of a particular kind, unless otherwise explicitly specified. Further, the descriptors “first,” “second,” “third,” etc. are used to distinguish among different items, and do not imply an ordering among items, unless otherwise noted. The phrase “A and/or B” means A, or B, or A and B. Further, the terms “comprising,” “including,” and “having” are open-ended terms that are used to identify at least one part of a larger whole, but not necessarily all parts of the whole. Finally, the terms “exemplary” or “illustrative” refer to one implementation among potentially many implementations.

In closing, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for identifying and applying a chosen machine-trained model, comprising:
receiving a specified latency constraint;
using neural architecture search to produce the chosen machine-trained model that satisfies the latency constraint, based on a collection of candidate machine-trained models,
different candidate machine-trained models in the collection of machine-trained models specifying different respective ways of reducing weights in a shared transformer-based neural network architecture, on a layer-by-layer basis; and
applying the chosen machine-trained model in a computer-implemented application system to perform an application task.

2. The computer-implemented method of claim 1, wherein the different candidate machine-trained models in the collection of candidate machine-trained models include attention layers having different numbers of attention heads and feed-forward neural network layers having different sizes.

3. The computer-implemented method of claim 1, wherein the neural architecture search includes:
selecting a parent model from the collection of candidate machine-trained models;
mutating the parent model using trainable logic, to produce a child model, the trainable logic having been trained to select a part of the parent model, to provide a selected part, and then to mutate the selected part;
generating a reward score for the child model that takes into consideration at least accuracy and latency of the child model;
adjusting the trainable logic that performs said mutating based on the reward score;
updating the collection of candidate machine-trained models based on the child model; and
repeating said selecting, mutating, generating, adjusting, and updating until a specified objective is achieved, to produce the chosen machine-trained model.

4. The computer-implemented method of claim 3, wherein said selecting operates by selecting the parent model based on latency and accuracy exhibited by the parent model, relative to latency and accuracy exhibited by other candidate machine-trained models.

5. The computer-implemented method of claim 3, wherein said mutating includes:
selecting a particular layer in the parent model, the particular layer being the selected part; and
for a case in which the particular layer is an attention layer, selecting a sparsity ratio that defines how many attention heads to remove in the attention layer, and for a case in which the particular layer is a feed-forward neural network layer, selecting another sparsity ratio that defines a reduction in weights in the feed-forward neural network layer.

6. The computer-implemented method of claim 3, wherein the latency that is used to generate the reward score is produced using trainable logic that performs prediction.

7. The computer-implemented method of claim 3, wherein the accuracy that is used to generate the reward score is produced by performing pruning on the parent model.

8. The computer-implemented method of claim 3, wherein said adjusting involves adjusting weights in the trainable logic that performs said mutating based on a reinforcement learning training objective.

9. The computer-implemented method of claim 3, wherein said updating involves adding the chosen machine-trained model to the collection of candidate machine-trained models, and removing at least one existing candidate machine-trained model from the collection of candidate machine-trained models.

10. The computer-implemented method of claim 1, wherein said applying includes:
receiving a target item;
as part of a preliminary operation, processing the target item to produce an analysis result for the target item, and storing the analysis result in a data store; and
using the chosen machine-trained model to process the target item for a case in which the analysis result has not yet been stored in the data store,
said applying relying on another machine-trained model, different from the chosen machine-trained model, when the analysis result has been stored in the data store.

11. The computer-implemented method of claim 1, wherein said applying includes:
receiving a query from a user;
forming a combination of the query and a first target item; and
based on the combination, determining a relevance score for the first target item using the chosen machine-trained model, the relevance score measuring a relevance of the query to the first target item.

12. The computer-implemented method of claim 11, wherein said applying further includes:
retrieving an item encoding vector for a second target item, the item encoding vector representing semantic content in the second target item and having been generated in an offline process prior to receipt of the query; and
determining a relevance score for the second target item using another machine-trained model, different from the chosen machine-trained model, based on the item encoding vector that is retrieved, the relevance score for the second target item measuring a relevance of the query to the second target item,
wherein the chosen machine-trained model is used in response to determining that an item encoding vector has not yet been generated for the first target item.

13. A computing system, comprising:
a computer-implemented application system having hardware logic circuitry configured to perform an application task,
the computer-implemented application system including a chosen machine-trained model,
the chosen machine-trained model being automatically generated by a neural network search (NAS) system, the NAS system including other hardware logic circuitry that is configured to perform operations of:
receiving a specified latency constraint; and
using neural architecture search to produce the chosen machine-trained model that satisfies the latency constraint, based on a collection of candidate machine-trained models,
different candidate machine-trained models in the collection of machine-trained models specifying different respective ways of reducing weights in a shared transformer-based neural network architecture, on a layer-by-layer basis.

14. The computing system of claim 13, wherein the neural network search includes:
selecting a parent model from the collection of candidate machine-trained models;
mutating the parent model using trainable logic, to produce a child model, the trainable logic having been trained to select a part of the parent model, to provide a selected part, and then to mutate the selected part;
generating a reward score for the child model that takes into consideration at least accuracy and latency of the child model;
adjusting the trainable logic that performs said mutating based on the reward score;
updating the collection of candidate machine-trained models based on the child model; and
repeating said selecting, mutating, generating, adjusting, and updating until a specified objective is achieved, to produce the chosen machine-trained model.

15. The computing system of claim 14, wherein said mutating includes:
selecting a particular layer in the parent model, the particular layer being the selected part; and
for a case in which the particular layer is an attention layer, selecting a sparsity ratio that defines how many attention heads to remove in the attention layer, and for a case in which the particular layer is a feed-forward neural network layer, selecting another sparsity ratio that defines a reduction in weights in the feed-forward neural network layer.

16. The computing system of claim 14,
wherein the latency that is used to generate the reward score is produced using trainable logic that performs prediction, and
wherein the accuracy that is used to generate the reward score is produced by performing pruning on the parent model.

17. The computing system of claim 13, wherein the hardware logic circuitry of the application system is configured to perform operations of:
receiving a query from a user;
forming a combination of the query and a first target item;
based on the combination, determining a relevance score for the first target item using the chosen machine-trained model, the relevance score measuring a relevance of the query to the first target item;
retrieving an item encoding vector for a second target item, the item encoding vector representing semantic content in the second target item and having been generated in an offline process prior to receipt of the query; and
determining a relevance score for the second target item using another machine-trained model, different from the chosen machine-trained model, based on the item encoding vector that is retrieved, the relevance score for the second target item measuring a relevance of the query to the second target item,
wherein the chosen machine-trained model is used in response to determining that an item encoding vector has not yet been generated for the first target item.

18. A computer-readable storage medium for storing computer-readable instructions, one or more hardware processors executing the computer-readable instructions to perform a method that comprises:
identifying a collection of candidate machine-trained models;
selecting a parent model from the collection of candidate machine-trained models;
mutating the parent model using trainable logic, to produce a child model, the trainable logic having been trained to select a part of the parent model, to provide a selected part, and then to mutate the selected part;
generating a reward score for the child model that takes into consideration at least accuracy and latency of the child model;
adjusting the trainable logic that performs said mutating based on the reward score;
updating the collection of candidate machine-trained models based on the child model; and
repeating said selecting, mutating, generating, adjusting, and updating until a specified objective is achieved, to produce a chosen machine-trained model.

19. The computer-readable storage medium of claim 18, wherein said mutating includes:
selecting a particular layer in the parent model, the particular layer being the selected part; and
for a case in which the particular layer is an attention layer, selecting a sparsity ratio that defines how many attention heads to remove in the attention layer, and for a case in which the particular layer is a feed-forward neural network layer, selecting another sparsity ratio that defines a reduction in weights in the feed-forward neural network layer.

20. The computer-readable storage medium of claim 18, wherein the latency that is used to generate the reward score is produced using trainable logic that performs prediction.
